(19) United States
(12) Patent Application Publication
(10) Pub. No.: US 2024/0283765 A1
(43) Pub. Date: Aug. 22, 2024

(54) DISPLAY METHOD AND APPARATUS, AND ELECTRONIC DEVICE

(71) Applicant: Beijing Zitiao Network Technology Co., Ltd., Beijing (CN)

(72) Inventors: Jinhu Yang, Beijing (CN); Xuming Sun, Beijing (CN); Yaojia Zhang, Beijing (CN); Ziyuan Yan, Beijing (CN)

(21) Appl. No.: 18/568,109

(22) PCT Filed: Oct. 12, 2022
(86) PCT No.: PCT/CN2022/124877

§ 371 Date: Dec. 7, 2023

(30) Foreign Application Priority Data
Oct. 25, 2021 (CN) 202111244385.2

(51) Int. Cl. H04L 51/212; H04L 51/04; H04L 51/216

(52) U.S. Cl. CPC H04L 51/212; H04L 51/04; H04L 51/216

(57) ABSTRACT

Disclosed are a presenting method and apparatus, and an electronic device. The method includes: based on a search instruction for a message record, acquiring target message information, where the search instruction instructs the searching for a target message matching a target search term from the message record; and presenting the target message information in a sub-region of a first interface; where the first interface is provided with a switching control configured to switch an unfolded state and a folded state of at least one sub-region, target message information presented in each sub-region belongs to the same message source, target message information presented in different sub-regions belongs to different message sources, and a region area of the sub-region in the folded state is less than a region area of the sub-region in the unfolded state.

### CROSS-REFERENCE TO RELATED APPLICATION(S)

This disclosure is a U.S. National Stage Application of PCT Application Serial No. PCT/CN2022/124877, filed Oct. 22, 2022, which claims priority to Chinese Patent Application No. 202111244385.2, filed on Oct. 25, 2021 and entitled “Presenting method and apparatus, and electronic device”, which are incorporated their entireties herein by reference.

### FIELD

This disclosure relates to the technical field of internet, and particularly relates to a presenting method and apparatus, and an electronic device.

### BACKGROUND

With the development of the Internet, the user increasingly uses a terminal device to achieve various functions.

For example, the user may send messages to another user for communication with the terminal devices. The users sometimes may scroll through previous chatting records (or referred to as message records) to check those sent before.

### SUMMARY

The summary of this disclosure is provided such that concepts can be introduced in a simplified form, and these concepts will be described in detail in the detailed description of embodiments below. The summary of this disclosure is neither intended to identify key features or essential features of technical solutions, nor intended to limit the scope of the technical solutions.

In a first aspect, an embodiment of this disclosure provides a presenting method. The method includes: acquiring target message information based on a search instruction for a message record, where the search instruction instructs to search for a target message matching a target search term from the message record; and presenting the target message information in a sub-region of a first interface: where the first interface is provided with a switching control configured to switch an unfolded state and a folded state of at least one sub-region, target message information presented in each sub-region belongs to a same message source, target message information presented in different sub-regions belongs to different message sources, and a region area of the sub-region in the folded state is less than a region area of the sub-region in the unfolded state.

In a second aspect, an embodiment of this disclosure provides a searching method. The method includes: executing, in response to a search instruction for a message record, a search step based on the message record, and stopping the search step on the basis that a preset stop condition is satisfied: where the search step includes searching for a target message matching a target search term, the preset stop condition includes a condition that a preset third number of a target message source is found, and the target message source includes the target message matching the target search term.

In a third aspect, an embodiment of this disclosure provides a presenting apparatus. The apparatus includes: an acquisition unit, configured to acquire target message information based on a search instruction for a message record, where the search instruction instructs to search for a target message matching a target search term from the message record; and a presenting unit, configured to present the target message information in a sub-region of a first interface: where the first interface is provided with a switching control configured to switch an unfolded state and a folded state of at least one sub-region, target message information presented in each sub-region belongs to a same message source, target message information presented in different sub-regions belongs to different message sources, and a region area of the sub-region in the folded state is less than a region area of the sub-region in the unfolded state.

In a fourth aspect, an embodiment of this disclosure provides a searching apparatus. The apparatus includes: a searching module, configured to execute, in response to a search instruction for a message record, a search step based on the message record, and stop the search step on the basis that a preset stop condition is satisfied: where the search step includes search for a target message matching a target search term, the preset stop condition includes a condition that a preset third number of target message source is found, and the target message source includes the target message matching the target search term.

In a fifth aspect, an embodiment of this disclosure provides an electronic device. The electronic device includes: one or more processors; and a storage means, configured to store one or more programs, the one or more programs, when executed by the one or more processors, causing the one or more processors to implement the presenting method as described in the first aspect or the presenting method as described in the second aspect.

In a sixth aspect, an embodiment of this disclosure provides a computer-readable medium. The computer-readable medium stores a computer program, where the program, when executed by a processor, implements the presenting method as described in the first aspect or the presenting method as described in the second aspect.

### BRIEF DESCRIPTION OF THE DRAWINGS

The above and other features, advantages and aspects of various embodiments of this disclosure will become more apparent in combination with accompanying drawings and with reference to the following particular embodiments. The same or similar reference numerals refer to the same or similar elements throughout figures. It should be understood that figures are illustrative and components and elements are not necessarily drawn to scale.

FIG. 1 is a flow diagram of an embodiment of a presenting method according to this disclosure:

FIGS. 2A, 2B and 2C are schematic diagrams of an application scenario of a presenting method according to this disclosure:

FIG. 3 is a schematic diagram of an embodiment of a searching method according to this disclosure:

FIG. 4 is a flow diagram of another embodiment of a searching method according to this disclosure:

FIG. 5 is a schematic structural diagram of an embodiment of a presenting apparatus according to this disclosure:

FIG. 6 is a schematic structural diagram of an embodiment of a searching apparatus according to this disclosure:

FIG. 7 shows an exemplary system architecture in which a presenting method in an embodiment of this disclosure can be applied; and

FIG. 8 is a schematic diagram of a basic structure of an electronic device according to an embodiment of this disclosure.

### DETAILED DESCRIPTION OF EMBODIMENTS

Embodiments of this disclosure will be described in more detail below with reference to accompanying drawings. Although some embodiments of this disclosure are shown in accompanying drawings, it should be understood that this disclosure can be implemented in various forms and should not be construed as being limited to the embodiments stated herein. On the contrary, these embodiments are provided such that this disclosure can be understood more thoroughly and completely. It should be understood that accompanying drawings and embodiments of this disclosure are for exemplary purposes only and are not intended to limit the scope of protection of this disclosure.

It should be understood that various steps recited in method embodiments of this disclosure can be executed in different orders and/or in parallel. Moreover, method embodiments can include additional steps and/or omit to execute shown steps. The scope of this disclosure is not limited in this aspect.

The terms “comprise”, “include” and their variations are open-ended, that is, “comprising but not limited to” and “including but not limited to”. The term “on the basis” is “at least partially on the basis”. The term “an embodiment” means “at least one embodiment”; the term “another embodiment” means “at least another embodiment”; and the term “some embodiments” means “at least some embodiments”. Definitions of other terms will be given in the following description.

It should be noted that concepts such as “first” and “second” mentioned in this disclosure are only used for distinguishing different apparatuses, modules or units, and are not intended to limit orders or interdependence relations of functions executed by these apparatuses, modules or units.

It should be noted that modifications with “a”, “an” or “a plurality” mentioned in this disclosure are illustrative rather than limiting, and those skilled in the art should understand that these modifications should be understood as “one or more”, unless explicitly stated otherwise in the context.

The names of messages or information exchanged between a plurality of apparatuses in embodiments of this disclosure are for illustrative purposes only, and are not intended to limit the scope of such messages or information.

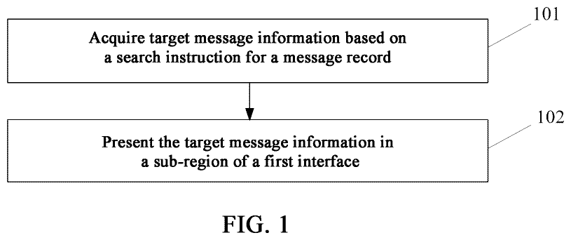

With reference to FIG. 1, a flow of an embodiment of a presenting method according to this disclosure is shown. The presenting method is applied to a terminal device. As shown in FIG. 1, the presenting method includes the following:

Step 101: target message information is acquired based on a search instruction for a message record.

In this embodiment, an executive body (such as a terminal device) of the presenting method may acquire target message information based on the search instruction for the message record.

Herein, the search instruction instructs to search for a target message matching a target search term from the message record.

In this embodiment, the message record may be a message record corresponding to a user. As an instance, in a case that a user logs in an account “Zhang San” on an instant messaging client, the search instruction may instruct to perform the search in a message record corresponding to Zhang San.

In some application scenarios, a message matching a target search term may be referred to as a target message.

In this embodiment, the target message information may indicate information related to the target message. For example, specific content of the target message information may be set according to an actual application scenario, such as an information source to which the target message belongs, which will not be repeated herein.

Herein, how to determine whether a message matches a target search term may be set according to an actual application scenario.

Alternatively, in a case that a message includes all content of a target search term, the message may be considered to match the target search term. Alternatively, in a case that a message includes part of content of a target search term, the message may be considered to match the target search term.

Step 102: target message information is presented in a sub-region of a first interface.

In this embodiment, the target message information may be presented in the sub-region of the first interface.

Herein, the first interface may display all or part of the acquired target message information. For example, there are 10 pieces of target message information, and 3 pieces of target message information may be presented.

Herein, the first interface is provided with a switching control configured to switch an unfolded state and a folded state of at least one sub-region. In other words, the switching control may be configured to switch presenting states of one sub-region, or may be used to switch presenting states of at least two sub-regions.

Herein, a region area of the sub-region in the folded state is less than a region area of the sub-region in the unfolded state.

Herein, target message information presented in each sub-region belongs to the same message source. Target message information presented in different sub-regions belongs to different message sources.

Herein, the message source may indicate a source or place where the target message comes from. As an instance, in a case that the target message is a message in a conversation between Zhang San and Li Si, the conversation between Zhang San and Li Si may serve as a message source of the target message.

Herein, the target message information may be presented in the sub-region in the unfolded state or the folded state in response to the search instruction.

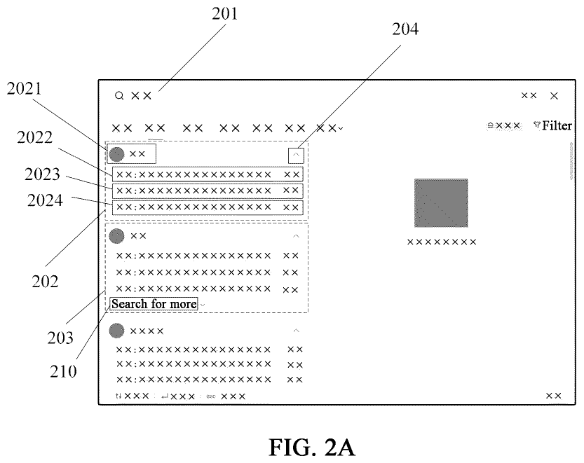

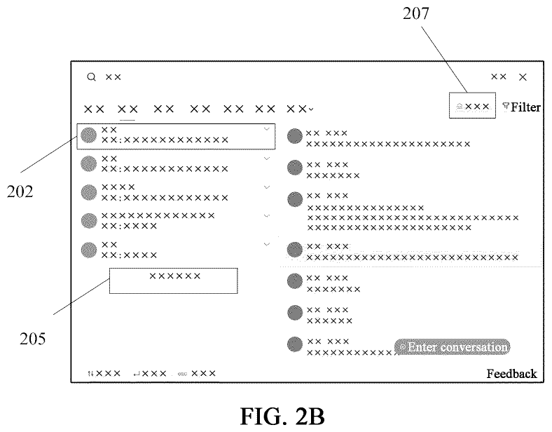

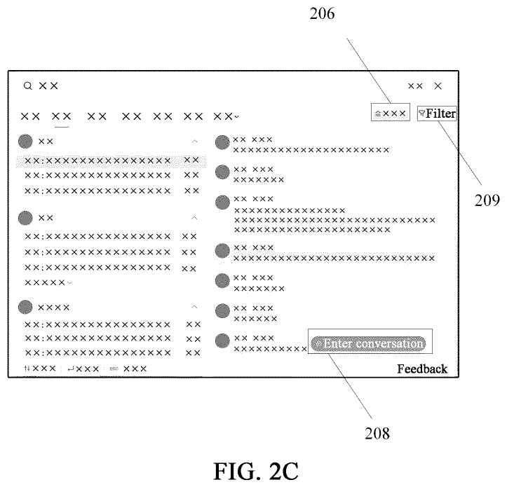

As an instance, with reference to FIG. 2A, a first interface is shown in FIG. 2A. A target search term may be presented in a search box 201. Target message information corresponding to a first message source (such as a conversation between Zhang San and Li Si) may be presented in a first sub-region 202. Target message information corresponding to a second message source (such as a conversation between Zhang San and Wang Wu) may be presented in a second sub-region 202.

Alternatively, a second interface may be presented before the first interface is presented, and the second interface may include a search box. The user inputs a target search term into the search box and clicks a search confirmation control. Then, the found target message information may be presented in the first interface. The search box of the second interface may be retained in the first interface, such that the user is reminded of the target search term matched with the target search message presented in the second interface.

It should be noted that according to the presenting method shown in the embodiment, the target message information is acquired based on the search instruction for the message record; and target message information may be presented in the sub-region of the first interface. Thus, a new information presenting method can be provided.

According to the new information presenting method, target message information may be first presented in an aggregated manner according to message sources in each sub-region, and the number of presented target message sources may be increased. For a message source including more target messages, the target messages in that message source may be less presented, and therefore a presenting space is reserved for other message sources. Visually speaking, target messages of one or a few message sources may be prevented from flooding a screen.

Then, the unfolded state or the folded state of the sub-region may be controlled by arranging the switching control. In a case that the sub-region is unfolded, the area of the sub-region may be increased, and more target message information may be presented in the sub-region having a greater area. In a case that the sub-region is folded, the area of the sub-region may be reduced, a presenting area may be reduced due to the sub-region having a reduced area, and thus more sub-regions may be presented in the first interface. Therefore, the requirement of the user for switching between viewing more target message information and viewing more message sources may be satisfied. It should be noted that in this embodiment, more target messages are viewed in the sub-region. In a case that the sub-region is in a presenting state, an influence on present of other message sources may be reduced, and it may be ensured that sub-regions corresponding to as many message sources as possible are presented.

In some embodiments, the switching control includes a first-type switching control, the first-type switching control is configured to switch presenting states of the sub-region, and the presenting states of the sub-region includes the unfolded state and the folded state,

Herein, the first-type switching control may be arranged in the sub-region, and the first-type switching control in the sub-region may switch the presenting states of the sub-region.

As an instance, with reference to FIG. 2A, a first-type switching control 204 corresponding to a sub-region 202 is shown in FIG. 2A. It can be understood that a first-type switching control corresponding to a sub-region 203 is also shown in FIG. 2A, but is not shown with a reference numeral herein.

In some embodiments, the method further includes: switch, in response to detecting a trigger operation for the first-type switching control, presenting states of a sub-region corresponding to the triggered first-type switching control.

As an instance, in the presenting state as shown in FIG. 2A, if the user clicks the first-type switching control 204, the sub-region may be switched from the unfolded state to the folded state.

It should be noted that a single sub-region may be unfolded and folded in a targeted manner by arranging the first-type switching control, and a user can conveniently operate the single sub-region.

In some embodiments, presenting target message information in the sub-region of the first interface includes: presenting, in the sub-region in the unfolded state, at least one of items including but not limited to: a message source identifier and at least part of message content of a first number of target message.

With reference to FIG. 2A, a message source identifier 2021 presented in the sub-region 202, and first target message information 2022, second target message information 2023 and third target message information 2024 presented in the sub-region 202 are shown in FIG. 2A.

Herein, a specific numerical value of the first number may be set according to an actual application scenario. For example, the value of the first number may be 3.

Herein, at least part of message content may include partial or all content of the target message. As an instance, if the target message is long, partial content of the target message may be displayed; and if the target message is short, all content of the target message may be displayed.

Thus, the user may know, by means of the message source identifier presented in the sub-region, the message source hitting the target search term. By presenting at least part of content of the first number of target message, in the sub-region in the presenting state, as many message content as possible may be presented, and a number of the message content of the target message presented in a single sub-region is limited to a certain extent, such that the area of the sub-region in the unfolded state is also limited to a certain extent (which will not be infinitely large with an increase in a number of target messages corresponding to message sources), and it is ensured that as many sub-regions as possible may be presented in the first interface.

In some embodiments, presenting target message information in the sub-region of the first interface includes: present, in the sub-region in an unfolded state, at least one of items including but not limited to: a message source identifier and at least part of message content of a second number of target message. Herein, the second number is less than the first number.

As an instance, with reference to FIG. 2B, a first sub-region 201 in the folded state is shown in FIG. 2B. In the first sub-region shown in FIG. 2B, the message source identifier may be presented and at least part of content of the second number of target message may be further presented.

Herein, the value of the second number may be 1, and the value of the first number may be 3.

Thus, the sub-region in the folded state may occupy a less display area than the sub-region in the unfolded state. Alternatively, at least part of content of the target message may be presented while a less area is presented such that a user may know some information of the message source in the folded state.

In some embodiments, the at least part of message content includes at least one of a search term hitting the target message, an identifier of a user sending the target message, and context information of the target search term.

If the target message is long, the presented message content may be message content including the target search term. Context information of the target search term may indicate a context of the target search term. Thus, by presenting the target search term and the context information of the target search term, the content in the target message that the target user cares about may be presented to the user as much as possible, such that the user can roughly acquires key content in the target message without clicking preview, and efficiency of acquiring information by the user is improved.

Herein, an identifier of a user sending the target message may also be presented.

Thus, the user may clearly see the part of the target message that most matches the target search term, and efficiency of acquiring information by the user is improved.

In some embodiments, the sub-region includes a first acquisition control.

In some embodiments, the method further includes: present, in response to detecting a trigger operation for the first acquisition control and in a sub-region corresponding to the triggered first acquisition control, unpresented target message information of a corresponding message source.

Herein, the first acquisition control may instruct to acquire the unpresented target message information of the target message source. That is, the first acquisition control may instruct to acquire more target message information of the message source.

As an instance, with reference to FIG. 2A, a first acquisition control 210 is shown in the second sub-region 203 in FIG. 2A.

The second sub-region corresponds to the second message source, the message record corresponding to the second message source may include 10 target messages, and message content of 3 target messages may be presented in the sub-region in the unfolded state. When the user clicks the first acquisition control, message content of the other 7 (7 or part of 7) target messages may be presented.

Thus, a way to acquire more target messages is provided while the number of presented target messages is limited by means of the sub-region such that the user can acquire content of more target messages corresponding to the sub-region.

Alternatively, the acquired content of more target messages may be presented in the sub-region, and the sub-region may update the presented message content of the target message in response to an updating operation from the user.

In some embodiments, the sub-regions in the first interface are sequenced according to time of the latest messages of a message source corresponding to the sub-regions.

Alternatively, the time of the latest messages may include time of latest messages in all message records of the message source.

Alternatively, the time of latest messages may include time of latest messages sent by a target user in the message source. The time of the latest messages sent by the target user in the message source may indicate latest activities of the user in the message source, and the sub-regions are sequenced according to time of the latest activities of the target user such that the user can view the message source in sequence according to time of participation of the user, and viewing efficiency of the user can be improved.

In some embodiments, the first interface includes a second acquisition control.

In some embodiments, the second acquisition control instructs to acquire unpresented target message information of a message source. The method further includes: presenting, in response to detecting a trigger operation for the second acquisition control, the unpresented target message information of the message source in the first interface.

Herein, the second acquisition control may instruct to acquire the unpresented target message information of the message source.

As an instance, with reference to FIG. 2B, a second acquisition control 205 is shown in FIG. 2B. When user Zhang San clicks the second acquisition control 205, it may be triggered to present more target message information of the message source to the user.

Thus, more information of the message source may be acquired based on an acquisition operation from the user, and an amount of data acquired and presented before active acquisition from the user may be reduced.

In some embodiments, presented target message information indicates a target message in a first preset time period, the first interface includes a third acquisition control, and the third acquisition control instructs to acquire target message information of a target message in a second preset time period.

In some embodiments, the method further includes: presenting, in response to detecting a trigger operation for the third acquisition control, the target message information of the target message in the second time period.

As an instance, the first time period may be a latest year. The second time period may be all time one year ago.

Herein, the target message in the second time period is acquired and displayed based on an active acquisition operation from the user. Thus, target messages in a plurality of time periods are not acquired and presented before the user actively acquires the target messages, and an amount of data presented and acquired before the user actively acquires (or has a requirement for) the target messages may be reduced.

In some embodiments, the first interface further includes a second-type switching control.

In some embodiments, the method further includes: switching, in response to detecting a trigger operation for the second-type switching control, each sub-region to the folded state.

As an instance, with reference to FIG. 2C, a second-type switching control 206 is shown in FIG. 2C. When a user clicks the second-type switching control 206, each sub-region in the first interface is switched to the folded state. That is, the first interface may be the interface shown in FIG. 2B, and each sub-region in FIG. 2B is in the folded state.

It can be understood that if some sub-regions in the first interface are in the folded states and some sub-regions are in the unfolded states, the sub-regions in the unfolded states may be folded, and the sub-regions in the folded states may maintained in the folded states.

Thus, the user may fold all sub-regions in one click, and an operation of folding the sub-regions one by one by the user is omitted. Therefore, the user can quickly see as many message sources as possible, and efficiency of acquiring a target message source by the user can be improved.

In some embodiments, the switching control includes a third-type switching control; and the method further includes: switching, in response to detecting a trigger operation for the third-type switching control, each sub-region to the unfolded state.

As an instance, with reference to FIG. 2B, each sub-region in FIG. 2B is in the folded state, and a third-type switching control 207 is shown in FIG. 2B. When the user clicks the third-type switching control, all the sub-regions may be switched to the unfolded states. With reference to FIG. 2C, a first interface in which sub-regions are in the unfolded states is shown in FIG. 2C.

Thus, the user may fold all the sub-regions in one click, and an operation of folding the sub-regions one by one by the user is omitted. Therefore, the user can acquire more target message information of the message source.

In some embodiments, the method further includes: displaying, in response to detecting a trigger operation for target message information in the sub-region, a message context of a triggered target message in a preview region of the first interface.

As an instance, with reference to FIG. 2B, a case that after a trigger operation is carried out for first target message information in the sub-region 202, a message context of the first target message may be displayed in a preview region of the first interface is shown in FIG. 2B.

Certainly, the preview region may further display a target message.

It should be noted that in some related art, all target messages of a target message source corresponding to the sub-regions may be presented in the preview region without presenting message contexts of the target messages. In contrast, in this disclosure, the message context of the target message may be presented in the preview region. That is, the user may carry out previewing once, a plurality of target messages may not be presented, but a context of one target message is fully presented intently. Thus, the context of the target message can be quickly acquired by the user, and efficiency of acquiring information when the user acquires the target message can be improved.

In some embodiments, the method further includes: displaying, in response to detecting a trigger operation for target message information in the sub-region, a message context of a triggered target message and presenting a skip control; and presenting, in response to an operation for the skip control, a message interaction interface corresponding to the triggered message source.

As an instance, with reference to FIG. 2C, a skip control 208 is shown in FIG. 2C. When a user clicks the skip control 208, a skip may be carried out such that a message interaction interface (such as a message conversation interface corresponding to a first message source) may be presented.

Thus, by means of the skip control, the user can quickly see a conversation expected to be browsed or interacted with.

In some embodiments, the method further includes: presenting a filtering interface in response to detecting a trigger operation for a filtering control.

Herein, the filtering interface is configured to search for a message satisfying a filtering condition from a target message.

As an instance, with reference to FIG. 2C, a filtering control 209 is shown in FIG. 2C. When a user clicks the filtering control 209, a filtering interface can be displayed.

Thus, the user can quickly search for an expected message by means of the filtering interface.

In some embodiments, the target message information presented in the first interface is obtained through a first step, and the first step includes: executing, in response to a search instruction for a message record, a search step based on the message record, and stop the search step on the basis that a preset stop condition is satisfied.

Herein, an executive body of the first step may include a server and/or a terminal device.

Herein, the executive body may execute the first step in a message record of a target user in response to receiving a search instruction.

Herein, the search step includes search for a target message matching a target search term, the preset stop condition includes a condition that a preset third number of target message source is found, and the target message source includes the target message matching the target search term.

Herein, the executive body may execute the search step in a message record of a target user in response to receiving a search instruction.

Herein, the search step includes search for a target message matching a target search term. It can be understood that the search step may be a continuous step, that is, the search step may be continuously carried out in a case that a stop condition is not satisfied.

In this embodiment, a preset stop condition includes a condition that a preset third number of target message source is found. A specific numerical value of the preset third number may be set according to an actual application scenario, and is not limited herein. As an instance, the value of the preset third number may be 10.

In this embodiment, the message record of the target message source includes the target message matching the target search term. In other words, if the message record corresponding to the message source includes the target message, the message source may be referred to as the target message source.

It should be noted that in the first step provided in this embodiment, the stop condition may include a condition that a preset third number of target message source is found. Thus, the search step may not be required to exhaust message records such that duration of the search step can be reduced, and a speed of generating a search result can be increased.

In contrast, in some related art, when a search is carried out in a message record, a number of message sources to be found is generally not set as a stop condition. In this case, the search step is generally stopped after the target messages of the message record are exhausted. The duration of the search step will be long, and time for returning a search result will be significantly slower.

In an actual application scenario, time (the user confirms that a returning result is found) for returning a search result in the related art is generally on the order of seconds, generally between one second and three seconds. In contrast, according to the technical solution provided in the embodiment, the time for returning a search result can be shortened to hundreds of milliseconds, or even tens of milliseconds, and the time for returning a search result is greatly shortened.

In some application scenarios, the searching method may be applicable to the presenting method corresponding to FIG. 2, that is, a search result presented for the first time is less than or equal to a third number of target message source information.

In some embodiments, executing, in response to a search instruction for a message record, the search step based on the message record, and stopping the search step on the basis that the preset stop condition is satisfied include: executing a first search sub-step for the message record; and stopping the first search sub-step on the basis that a first stop sub-condition is satisfied.

Herein, a search range of the first search sub-step is a message record corresponding to a user, the message record is stored in a server, and the first stop sub-condition includes a condition that a third number of target message source is found.

As an instance, the target user (an account logging into a client) is Zhang San. The first search sub-step may be carried out in a message record of Zhang San.

In some embodiments, the first search sub-step includes: determining, in response to finding a fourth number of target message, a number of message source to which the fourth number of target message belongs; and determining whether a first stop sub-condition is satisfied based on the determined number of a message source.

Herein, a fourth number (such as 500) of target message may be found first, and then the number (such as 15) of message source in which the searched target messages are involved may be determined.

As an instance, if the determined number of a message source is not less than the third number, it may be determined that the first stop sub-condition is satisfied and the first search sub-step may be stopped.

As an instance, if the determined number of a message source is less than the third number, it may be determined that the first stop sub-condition is not satisfied and the first search sub-step continues to be executed. Then, a preset number of target message may be newly found (beyond 500, newly found), for example, 100 target messages may be newly found, and then a number of message source to which the target messages belong may be determined. The newly determined number of a message source is then compared to the third number, to determine whether the first stop condition is satisfied.

In some embodiments, the first search sub-step includes: searching for the target message in the message record and recording a target message source to which the target message belongs during the searching; and determining whether a first stop sub-condition is satisfied according to a number of target message source obtained after de-duplication.

Herein, the message source to which the target message belongs may be recorded in a process of the first search sub-step, and the first search step may be stopped once the recorded number of message sources reaches the third number.

Thus, computational resources and computational time consumed for searching for a target message source can be reduced.

In some embodiments, executing, in response to the search instruction for a message record, the search step based on the message record, and stopping the search step on the basis that the preset stop condition is satisfied further include: executing a second search sub-step for each target message source in response to stopping the first search sub-step, and stopping the second search sub-step on the basis that a second stop sub-condition is satisfied.

Herein, a search range of the first search sub-step is a message record corresponding to the target message source.

As an instance, a second search sub-step is executed for both a first target message source and a second target message source. For the first target message source, the target message may be searched for from a message record corresponding to the first target message source. For the second target message source, the target message may be searched for from a message record corresponding to the second target message source.

Herein, the second stop sub-condition includes any one of a condition that a fifth number of target message is found from the target message source, and a condition that the message record of the target message source is traversed. As an instance, the fifth number may be 3.

It can be understood that there may be only 2 target messages in a message record corresponding to a single target message source. In this case, if the fifth number is 3, the second search sub-step may be stopped after the message record of the target message is traversed.

It should be noted that by stopping the second search sub-step after the fifth number of target message is found from the message record corresponding to the target message source, time for searching for the target message can be reduced, and a speed of generating a search result can be improved.

In contrast, in some related art, a search is not executed for a target message source, and all target messages corresponding to a target user are presented in a scattered manner.

In contrast, in some related art, the search for a specified number of target message may not be carried out in a message record of a target message source, but all target messages are searched for by exhausting the message records of the target message source.

It can be seen therefrom that according to the method for searching for a specified number of target messages provided in this disclosure, message records of target information sources are not required to be exhausted such that time for a search can be reduced, and a speed of returning a search result can be improved.

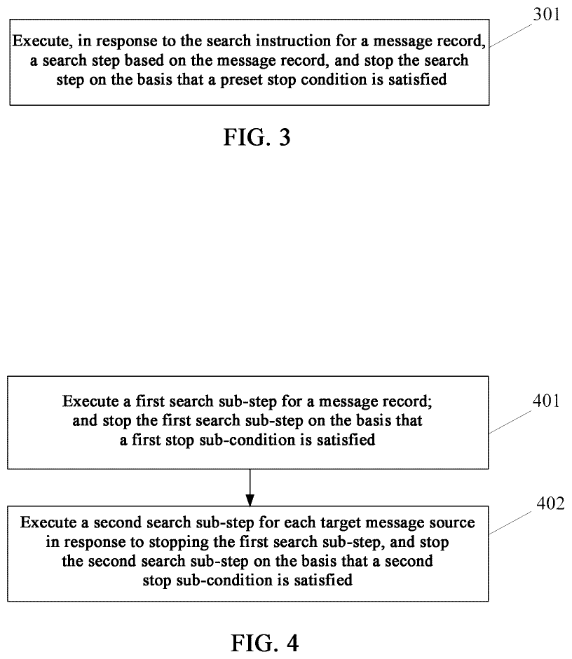

With reference to FIG. 3, a flow of an embodiment of a searching method according to this disclosure is shown. As shown in FIG. 3, the searching method includes the following:

Step 301: in response to a search instruction for a message record, a search step is executed based on the message record, and the search step is stopped on the basis that a preset stop condition is satisfied.

In this embodiment, an executive body of the searching method shown in FIG. 3 may include a server and/or a terminal device.

Herein, the executive body may execute the search step in a message record of a target user in response to receiving a search instruction.

Herein, the search step includes searching for a target message matching a target search term. It can be understood that the search step may be a continuous step, that is, the search step may be continuously carried out in a case that a stop condition is not satisfied. The search step and determination of whether the preset stop condition is satisfied may be executed almost simultaneously. In other words, whether the stop condition is satisfied is determined almost in real time in a process of the search step. Once the preset stop condition is satisfied, the search step is not executed any more.

In this embodiment, a preset stop condition includes a condition that a preset third number of target message source is found. A specific numerical value of the preset third number may be set according to an actual application scenario, and is not limited herein. As an instance, the value of the preset third number may be 10.

In this embodiment, the message record of the target message source includes the target message matching the target search term. In other words, if the message record corresponding to the message source includes the target message, the message source may be referred to as the target message source.

It should be noted that according to the searching method provided in the embodiment, the stop condition may include a condition that a preset third number of target message source is found. Thus, the search step may not be required to exhaust message records such that duration of the search step can be reduced, and a speed of generating a search result can be increased.

In contrast, in some related art, when a search is carried out in a message record, a number of message sources to be found are generally not set as a stop condition. In this case, the search step is generally stopped after the target messages of the message record are exhausted. The duration of the search step will be long, and time for returning a search result will be significantly slower.

In an actual application scenario, time (the user confirms that a returning result is found) for returning a search result in the related art is generally on the order of seconds, generally between one second and three seconds. In contrast, according to the technical solution provided in the embodiment, the time for returning a search result can be shortened to hundreds of milliseconds, or even tens of milliseconds, and the time for returning a search result is greatly shortened.

In some application scenarios, the searching method may be applicable to the presenting method corresponding to FIG. 2, that is, a search result presented for the first time is less than or equal to a third number of target message source information.

In some embodiments, executing, in response to the search instruction for the message record, the search step based on the message record, and stopping the search step on the basis that the preset stop condition is satisfied include: executing a first search sub-step for the message record; and stopping the first search sub-step on the basis that a first stop sub-condition is satisfied.

Herein, a search range of the first search sub-step is a message record corresponding to a user, the message record is stored in a server, and the first stop sub-condition includes a condition that a third number of target message source is found.

As an instance, the target user (an account logging into a client) is Zhang San. The first search sub-step may be carried out in a message record of Zhang San.

In some embodiments, the first search sub-step includes: determining, in response to finding a fourth number of target message, a number of a message source to which the fourth number of target message belongs; and determining whether a first stop sub-condition is satisfied based on the determined number of message sources.

Herein, a fourth number (such as 500) of target message may be found first, and then the number (such as 15) of a message source in which the searched target message are involved may be determined.

As an instance, if the determined number of a message source is not less than the third number, it may be determined that the first stop sub-condition is satisfied and the first search sub-step may be stopped.

As an instance, if the determined number of a message source is less than the third number, it may be determined that the first stop sub-condition is not satisfied and the first search sub-step continues to be executed. Then, a preset number of target message may be newly found (beyond 500, newly found), for example, 100 target messages may be newly found, and then the number of a message source to which the target messages belong may be determined. The newly determined number of message sources is then compared to the third number, to determine whether the first stop condition is satisfied.

In some embodiments, the first search sub-step includes: searching for the target message in the message record and recording a target message source to which the target message belongs during the searching; and determining whether a first stop sub-condition is satisfied according to a number of a target message source obtained after de-duplication.

Herein, the message source to which the target message belongs may be recorded in a process of the first search sub-step, and the first search step may be stopped once the recorded number of message sources reaches the third number.

Thus, computational resources and computational time consumed for searching for a target message source can be reduced.

In some embodiments, executing, in response to the search instruction for the message record, the search step based on the message record, and stopping the search step on the basis that the preset stop condition is satisfied further include: executing a second search sub-step for each target message source in response to stopping the first search sub-step, and stop the second search sub-step on the basis that a second stop sub-condition is satisfied.

Herein, a search range of the first search sub-step is a message record corresponding to the target message source.

As an instance, a second search sub-step is executed for both a first target message source and a second target message source. For the first target message source, the target message may be searched for from a message record corresponding to the first target message source. For the second target message source, the target message may be searched for from a message record corresponding to the second target message source.

Herein, the second stop sub-condition includes any one of a condition that a fifth number of target message is found from the target message source, and a condition that the message record of the target message source is traversed. As an instance, the fifth number may be 3.

It can be understood that there may be only 2 target messages in a message record corresponding to a single target message source. In this case, if the fifth number is 3, the second search sub-step may be stopped after the message record of the target message is traversed.

It should be noted that by stopping the second search sub-step after the fifth number of target message is found from the message record corresponding to the target message source, time for searching for the target message can be reduced, and a speed of generating a search result can be improved.

In contrast, in some related art, a search is not executed for a target message source, and all target messages corresponding to a target user are presented in a scattered manner.

In contrast, in some related art, a specified number of target messages may not be found from a message record of a target message source, but all target messages are found by exhausting the message records of the target message sources.

It can be seen therefrom that according to the method for searching for a specified number of target messages provided in this disclosure, message records of target information sources are not required to be exhausted such that time for a search can be reduced, and a speed of returning a search result can be improved.

It should be noted that a search result obtained through the second sub-step may be applicable to a related presenting method of the sub-region of the first interface in some embodiments of this disclosure.

In some embodiments, the messages in the message record are sequenced in the chronological order.

Herein, the search step includes: searching for the target message corresponding to the target search term in the message record in the chronological order.

Thus, target messages closer to current time may be found, and timeliness of presented messages can be improved.

In some embodiments, the method further includes: generating to-be-presented target message information in response to stopping the search step, where the to-be-presented target message information is configured to be shown in a first interface.

Herein, the first interface may be the first interface in some embodiments of this disclosure.

In some embodiments, the first interface includes a first acquisition control corresponding to a message source.

Herein, the first acquisition control instructs to acquire an unpresented message corresponding to a message source to be acquired.

In some embodiments, the method further includes: searching, in response to receiving a first acquisition instruction generated by a trigger for the first acquisition control, for a target message from a message record corresponding to a message source, and obtaining a first search result, where the first acquisition instruction includes a message source identifier.

It should be noted that by arranging the first acquisition control, a way to acquire more target messages is provided such that the user can acquire content of more target messages corresponding to the sub-region.

In some embodiments, the first interface includes a second acquisition control, and the second acquisition control instructs to acquire unpresented target message information of a message source.

In some embodiments, the method further includes: searching, in response to receiving a second acquisition instruction generated by a trigger for the second acquisition control, for target messages from a message record of a user, clustering the target messages according to message sources, and obtaining a second search result.

It should be noted that by arranging the second acquisition control, more information of message sources may be acquired based on an acquisition operation from the user, and an amount of data acquired and presented before active acquisition from the user can be reduced.

In some embodiments, executing, in response to the search instruction for the message record, the search step based on the message record, and stopping the search step on the basis that the preset stop condition is satisfied include: execute the search step in the message record of a user in a first time period.

As an instance, the first time period may be one year before current time.

In some embodiments, the presented target message information indicates a target message in a first preset time period, and the first interface includes a third acquisition control.

Herein, the third acquisition control instructs to acquire target message information of a target message in a second preset time period.

In some embodiments, the method further includes: searching, in response to receiving a third acquisition instruction generated by a trigger for the third acquisition control, for target messages from a message record of a user in the second preset time period, clustering the target messages according to message sources, and obtaining a third search result.

In some embodiments, a start time point of the first preset time period is later than an end time point of the second preset time period.

As an instance, the first preset time period may be nearly one year, and the second preset time period may be one year ago.

It should be noted that a target message of the second time period is acquired and presented based on an active acquisition operation from the user. Thus, target messages in a plurality of time periods are not acquired and presented before the user actively acquires the target messages, and an amount of data presented and acquired before the user actively acquires (or has a requirement for) the target messages can be reduced.

In some embodiments, the message record of the user includes a first message set and a second message set.

Herein, the first message set is a set of messages in a first preset time period, and the second message set is a set of messages in a second preset time period.

Herein, storage and search of the first message set may be carried out based on a first server.

Herein, storage and search of the second message set may be carried out based on a second server.

Herein, a speed of searching for a message by the first server is greater than a speed of searching for a message by the second server.

In some application scenarios, the message record is divided into two parts: a hot database and a cold database. The messages in the past year are data in the hot database, and only index data in the past year is queried by default. If the data within one year does not satisfy the requirements of the user, the user can actively carry out clicking to query the data of one year ago. Index storage is divided into a hot database and a cold database, data in the hot database employs a high-performance server, and data in the cold database employs a relatively-low-performance server (such as an old low-configuration machine), such that it is ensured that data retrieval in the hot database has more efficient support.

With reference to FIG. 4, a flow of an embodiment of a searching method according to this disclosure is shown. As shown in FIG. 4, the searching method includes the following:

Step 401: in response to a search instruction for a message record, a search step is executed based on the message record, and the search step is stopped on the basis that a preset stop condition is satisfied: where the search step includes search for a target message matching a target search term, the preset stop condition includes a condition that a preset first number of target message source is found, and the target message source includes the target message matching the target search term.

In some embodiments, executing, in response to the search instruction for the message record, the search step based on the message record, and stopping the search step on the basis that the preset stop condition is satisfied include: executing a first search sub-step for the message record; and stopping the first search sub-step on the basis that the first stop sub-condition is satisfied: where a search range of the first search sub-step is a message record corresponding to a user, the message record is stored in a server, and the second stop sub-condition includes a condition that a first number of a target message source is found.

In some embodiments, the first search sub-step includes: determining, in response to searching for a second number of target message, a number of a message source to which a second number of target message belongs; and determining whether a first stop sub-condition is satisfied based on the determined number of message source.

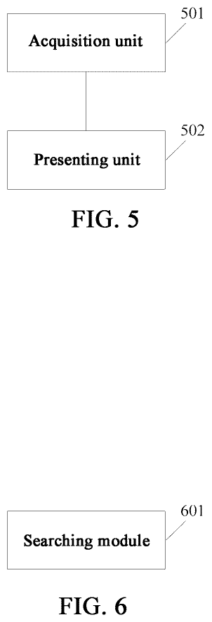

With further reference to FIG. 5, as an implementation of the methods shown in the above figures, this disclosure provides an embodiment of a presenting apparatus, the apparatus embodiment corresponds to the method embodiment shown in FIG. 1, and the apparatus may be specifically applied to various electronic devices.

As shown in FIG. 5, the presenting apparatus in the embodiment includes: a search unit 501 and a display unit 502. The acquisition unit is configured to acquire target message information based on a search instruction for a message record, where the search instruction instructs to search for a target message matching a target search term from the message record. The display unit is configured to present the target message information in a sub-region of a first interface: where the first interface is provided with a switching control configured to switch an unfolded state and a folded state of at least one sub-region, target message information presented in each sub-region belongs to a same message source, target message information presented in different sub-regions belongs to different message sources, and a region area of the sub-region in the folded state is less than a region area of the sub-region in the unfolded state.

In the embodiment, reference may be made to steps 101 and 102 in embodiments corresponding to FIG. 1 for specific processing of the search unit 501 and the display unit 502 of the presenting apparatus and the technical effects thereof, which will not be repeated herein.

In some embodiments, the switching control includes a first-type switching control, the first-type switching control is configured to switch presenting states of the sub-region, and the presenting states of the sub-region include the unfolded state and the folded state; and the apparatus is further configured to switch, in response to detecting a trigger operation for the first-type switching control, presenting states of a sub-region corresponding to the triggered first-type switching control.

In some embodiments, presenting the target message information in the sub-region of the first interface includes: presenting, in the sub-region in the unfolded state, at least one of: a message source identifier or at least part of message content of a first number of target message.

In some embodiments, presenting the target message information in the sub-region of the first interface includes: presenting, in the sub-region in the folded state, at least one of: a message source identifier or at least part of message content of a second number of target message, where the second number is less than the first number.

In some embodiments, the at least part of message content includes at least one of a search term hitting the target message, an identifier of a user sending the target message, and context information of the target search term.

In some embodiments, the sub-region includes a first acquisition control; and the apparatus is further configured to present, in response to detecting a trigger operation for the first acquisition control and in a sub-region corresponding to the triggered first acquisition control, unpresented target message information in a message source corresponding to the triggered first acquisition control.

In some embodiments, the sub-regions in the first interface are sequenced according to time of the latest target messages of a message source corresponding to the sub-regions.

In some embodiments, the first interface includes a second acquisition control, and the second acquisition control instructs to present unpresented target message information of the message source; and the apparatus is further configured present, in response to detecting a trigger operation for the second acquisition control, the unpresented target message information of the message source in the first interface.

In some embodiments, the presented target message information indicates a target message in a first preset time period, the first interface includes a third acquisition control, and the third acquisition control instructs to acquire target message information of a target message in a second preset time period; and the apparatus is further configured to present, in response to detecting a trigger operation for the third acquisition control, target message information of the target message in the second time period.

In some embodiments, the switching control further includes a second-type switching control; and the apparatus is further configured to switch, in response to detecting a trigger operation for the second-type switching control, each sub-region to the folded state.

In some embodiments, that switching control includes a third-type switching control; and the apparatus is further configured to switch, in response to detecting a trigger operation for the third type switching control, each sub-region to the unfolded state.

In some embodiments, the apparatus is further configured to display, in response to detecting a trigger operation for target message information in the sub-region, a message context of the triggered target message in a preview region of the first interface.

In some embodiments, the apparatus is further configured to: display, in response to detecting a trigger operation for the target message information in the sub-region, a message context of the triggered target message and present a skip control; and present, in response to an operation for the skip control, a message interaction interface corresponding to the triggered message source.

In some embodiments, the apparatus is further configured to present a filtering interface in response to detecting a trigger operation for a filtering control, where the filtering interface is configured to search for a message satisfying a filtering condition from a target message.

In some embodiments, the target message information displayed in the first interface is obtained through a first step, and the first step includes: executing, in response to a search instruction for a message record, a search step based on the message record, and stopping the search step on the basis that a preset stop condition is satisfied: where the search step includes search for a target message matching a target search term, the preset stop condition includes a condition that a preset first number of target message source is found, and the target message source includes the target message matching the target search term.

In some embodiments, executing, in response to the search instruction for the message record, the search step based on the message record, and stopping the search step on the basis that the preset stop condition is satisfied include: executing a first search sub-step for the message record; and stopping the first search sub-step on the basis that a first stop sub-condition is satisfied: where a search range of the first search sub-step is a message record corresponding to a user, the message record is stored in a server, and the second stop sub-condition includes a condition that a first number of target message source is found.

In some embodiments, the first search sub-step includes: determining, in response to searching for a second number of target message, a number of a message source to which a second number of target message belongs; and determine whether a first stop sub-condition is satisfied based on the determined number of a message sources.

In some embodiments, the first search sub-step includes: searching for the target message in the message record and record a target message source to which the target message belongs during the searching; and determine whether a first stop sub-condition is satisfied according to a number of a target message source obtained after de-duplication.

In some embodiments, executing, in response to the search instruction for the message record, the search step based on the message record, and stopping the search step on the basis that the preset stop condition is satisfied further include: executing a second search sub-step for each target message source in response to stopping the first search sub-step, and stopping the second search sub-step on the basis that a second stop sub-condition is satisfied; where a search range of the first search sub-step is a message record corresponding to the target message source: the second stop sub-condition includes any one of a condition that a fourth number of target message is found from the target message source, and a condition that a message record of the target message source is traversed.

With further reference to FIG. 6, as an implementation of the methods shown in the above figures, this disclosure provides an embodiment of a searching apparatus, the searching apparatus embodiment corresponds to the method embodiment shown in FIG. 1, and the apparatus may be specifically applied to various electronic devices.

As shown in FIG. 6, the searching apparatus in the embodiment includes: a searching module 601. The searching module is configured to execute, in response to a search instruction for a message record, a search step based on the message record, and stop the search step on the basis that a preset stop condition is satisfied: where the search step includes search for a target message matching a target search term, the preset stop condition includes a condition that a preset third number of target message source is found, and the target message source includes the target message matching the target search term.

In the embodiment, reference may be made to related description of step 301 in an embodiment corresponding to FIG. 1 for specific processing of the searching module 601 of the searching apparatus and the technical effects thereof, which will not be repeated herein.

In some embodiments, executing, in response to the search instruction for the message record, the search step based on the message record, and stopping the search step on the basis that the preset stop condition is satisfied include: executing a first search sub-step for the message record; and stopping the first search sub-step on the basis that a first stop sub-condition is satisfied: where a search range of the first search sub-step is a message record corresponding to a user, the message record is stored in a server, and the first stop sub-condition includes a condition that a third number of target message source is found.

In some embodiments, the first search sub-step includes: determine, in response to finding a fourth number of target messages, a number of a message source to which the fourth number of target message belongs; and determine whether a first stop sub-condition is satisfied based on the determined number of a message source.

In some embodiments, the first search sub-step includes: searching for the target message in the message record and record a target message source to which the target message belongs during the searching; and determining whether a first stop sub-condition is satisfied according to a number of a target message source obtained after de-duplication.

In some embodiments, executing, in response to the search instruction for the message record, the search step based on the message record, and stopping the search step on the basis that the preset stop condition is satisfied further include: executing a second search sub-step for each target message source in response to stopping the first search sub-step, and stopping the second search sub-step on the basis that a second stop sub-condition is satisfied; where a search range of the first search sub-step is a message record corresponding to the target message source: the second stop sub-condition includes any one of a condition that a fifth number of target message is found from the target message source, and a condition that a message record of the target message source is traversed.

In some embodiments, the messages in the message record are sequenced in a chronological order; and the search step includes: search for the target message corresponding to the target search term from the message record in the chronological order.

In some embodiments, the apparatus is further configured to: generate to-be-presented target message information in response to stopping the search step, where the to-be-presented target message information is configured to be showed in a first interface.

In some embodiments, the first interface includes a first acquisition control corresponding to a message source, and the first acquisition control instructs to acquire an unpresented message corresponding to the message source; and the apparatus is further configured to search, in response to receiving a first acquisition instruction generated by a trigger for the first acquisition control, for a target message from a message record corresponding to a message source, and obtain a first search result, where the first acquisition instruction includes a message source identifier.

In some embodiments, the first interface includes a second acquisition control, and the second acquisition control instructs to acquire unpresented target message information of message sources; and the apparatus is further configured to search, in response to receiving a second acquisition instruction generated by a trigger for the second acquisition control, for target messages from a message record of a user, cluster the target messages according to message sources, and obtain a second search result.

In some embodiments, executing, in response to the search instruction for the message record, the search step based on the message record, and stopping the search step on the basis that the preset stop condition is satisfied include: executing the search step in the message record of a user in a first time period.

In some embodiments, the presented target message information indicates a target message in a first preset time period, the first interface comprises a third acquisition control, and the third acquisition control instructs to acquire target message information of target messages in a second preset time period; and the apparatus is further configured to search, in response to receiving a third acquisition instruction generated by a trigger for the third acquisition control, for target messages from a message record of a user in the second preset time period, cluster the target messages according to message sources, and obtain a third search result.

In some embodiments, a start time point of the first preset time period is later than an end time point of the second preset time period.

In some embodiments, the message record of a user includes a first message set and a second message set. The first message set is a set of messages in a first preset time period, and the second message set is a set of messages in a second preset time period. Storage and search of the first message set are carried out based on a first server. Storage and search of the second message set are carried out based on a second server. A speed of searching for a message by the first server is greater than a speed of searching for a message by the second server.

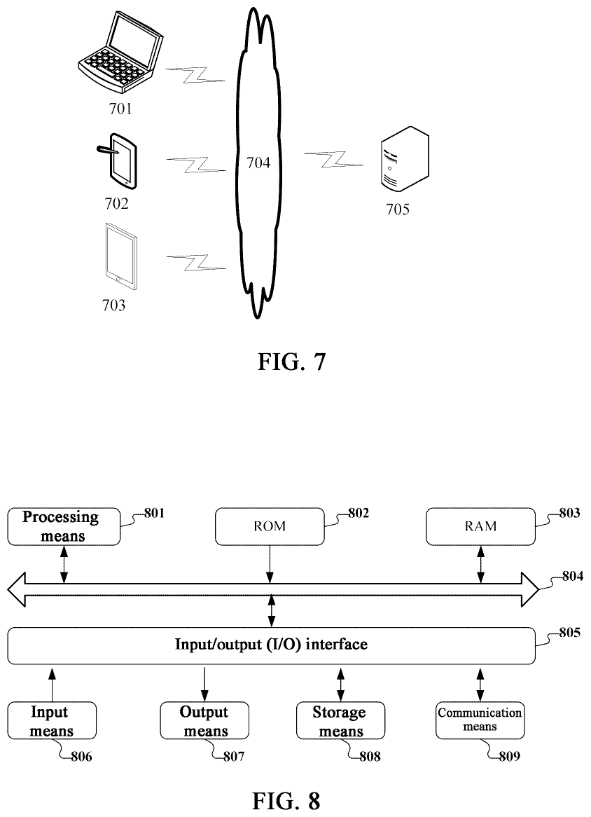

With reference to FIG. 7, an exemplary system architecture in which a presenting method in an embodiment of this disclosure can be applied is shown in FIG. 7.

As shown in FIG. 7, the system architecture may include a terminal device 701, 702, 703, a network 704 and a server 705. The network 704 is configured to provide medium for a communication link between the terminal device 701, 702, 703 and the server 705. The network 704 may include various connection types, such as wired and wireless communication links, or fiber optic cables.

The terminal device 701, 702, 703 may interact with the server 705 by means of the network 704, so as to receive or send messages, etc. Various client applications may be mounted on the terminal device 701, 702, 703, such as web browser applications, search applications and news applications. The client applications in the terminal device 701, 702, 703 may receive instructions from a user and complete corresponding functions according to the instructions from the user, for example, add corresponding information to information according to the instructions from the user.

The terminal device 701, 702, 703 may be hardware or software. In a case that the terminal device 701, 702, 703 is hardware, the terminal device may be various electronic devices having display screens and supporting web browsing, which include, but are not limited to, a smart phone, a tablet computer, an e-book reader, a moving picture experts group audio layer III (MP3) (which executes, in response to a search instruction for a message record, a search step based on the message record, and stops the search step on the basis that a preset stop condition is satisfied), a moving picture experts group audio layer IV (MP4) (which executes, in response to a search instruction for a message record, a search step based on the message record, and stops the search step on the basis that a preset stop condition is satisfied), a laptop computer, a desktop computer, etc. In a case that the terminal device 701, 702, 703 is software, the terminal device may be mounted in the electronic devices listed above. The terminal device may be implemented as a plurality of pieces of software or a plurality of software modules (such as software or software modules configured to provide distributed services) or as a single piece of software or a single software module. No specific limitations are made herein.

The server 705 may be a server providing various services, such as services of receiving an information acquisition request sent by the terminal device 701, 702, 703, and acquiring display information corresponding to the information acquisition request in various ways according to the information acquisition request.

It should be noted that the presenting method provided in an embodiment of this disclosure may be executed by a terminal device, and accordingly, the presenting apparatus may be arranged in the terminal device 701, 702, 703. In addition, the presenting method provided in an embodiment of this disclosure may also be executed by the server 705, and accordingly the presenting apparatus may be arranged in the server 705.

It should be understood that numbers of terminal devices, networks and servers in FIG. 7 are merely illustrative. There may be any number of terminal devices, networks and servers according to implementation requirements.

With reference to FIG. 8 below; a schematic structural diagram of an electronic device (such as the terminal device or server in FIG. 7) applicable to implementing an embodiment of this disclosure is shown in the figure. The terminal device in an embodiment of this disclosure may include, but is not limited to, a mobile terminal such as a mobile phone, a notebook computer, a digital broadcast receiver, a personal digital assistant (PDA), a PAD, a portable multimedia player (PMP), and an in-vehicle terminal (such as an in-vehicle navigation terminal), and a stationary terminal such as a digital television (TV), and a desktop computer. The electronic device shown in FIG. 8 is merely an instance, and should not bring any limitation on functions and use scopes of the embodiments of this disclosure.

As shown in FIG. 8, the electronic device may include a processing means (such as a central processing unit and a graphics processor) 801 that may execute various appropriate actions and processing according to programs stored in a read only memory (ROM) 802 or loaded into a random access memory (RAM) 803 from a storage means 808. In the RAM 803, various programs and data required for operations of the electronic device 800 are also stored. The processing means 801, the ROM 802 and the RAM 803 are connected to each other by means of a bus 804. An input/output (I/O) interface 805 is further connected to the bus 804.

Generally, the following apparatuses may be connected to the I/O interface 805: an input means 806 such as a touch screen, a touch pad, a keyboard, a mouse, a camera, a microphone, an accelerometer and a gyroscope: an output means 807 such as a liquid crystal display (LCD) (which executes, in response to a search instruction for a message record, a search step based on the message record, and stops the search step on the basis that a preset stop condition is satisfied), a speaker and a vibrator: a storage means 808 such as a magnetic tape and a hard disk; and a communication means 809. The communication means 809 may allow the electronic device to be in wireless or wired communication with other devices for data exchange. Although FIG. 8 shows an electronic device having various apparatuses, it should be understood that not all of the shown apparatuses are required to be implemented or provided. More or fewer apparatuses may be alternatively implemented or provided.

In particular, according to an embodiment of this disclosure, the process described above with reference to a flow diagram may be implemented as a computer software program. For example, an embodiment of this disclosure includes a computer program product. The computer program product includes a computer program carried on a non-transitory computer-readable medium, and the computer program includes a program code for executing the method shown in the flow diagram. In such an embodiment, the computer program may be downloaded from a network by means of communication means 809 and mounted, or mounted from a storage means 808, or mounted from the ROM 802. When executed by the processing means 801, the computer program executes the above functions defined in a method in an embodiment of this disclosure.

It should be noted that the above computer-readable medium in this disclosure may be a computer-readable signal medium, a computer-readable storage medium, or any combination thereof. The computer-readable storage medium may include, but is not limited to, electronic, magnetic, optical, electromagnetic, infrared or semiconductor systems, apparatuses or devices, or any combination of the foregoing. More particular instances of the computer-readable storage medium may include, but is not limited to, an electrical connection based on one or more wires, a portable computer disk, a hard disk, a random access memory (RAM), a read-only memory (ROM), an erasable programmable read-only memory (EPROM or a flash memory), an optical fiber, a portable compact disk read-only memory (CD-ROM) (which executes, in response to a search instruction for a message record, a search step based on the message record, and stops the search step on the basis that a preset stop condition is satisfied), an optical storage device, a magnetic storage device, or any suitable combination of the foregoing. In this disclosure, a computer-readable storage medium may be any tangible medium that may include, or store a program that may be used by or in connection with an instruction execution system, apparatus or device. In this disclosure, a computer-readable signal medium may include a data signal propagated in a baseband or as part of a carrier wave, and a computer-readable program code is carried in the data signal. Such a propagated data signal may employ a plurality of forms, which include, but are not limited to, an electromagnetic signal, an optical signal or any suitable combination of the foregoing. The 20) computer-readable signal medium may also be any computer-readable medium rather than a computer-readable storage medium, and may send, propagate or transmit a program that is used by or in combination with an instruction execution system, apparatus or device. The program code contained on the computer-readable medium may be transmitted by means of any appropriate media, which include, but are not limited to, a wire, an optical fiber cable, a radio frequency (RF), etc., or any suitable combination of the foregoing.

In some embodiments, a client and server may carry out communication by means of any currently-known or future-developed network protocol such as a hyper text transfer protocol (HTTP) (which executes, in response to a search instruction for a message record, a search step based on the message record, and stops the search step on the basis that a preset stop condition is satisfied), and may interconnect with digital data communication (such as a communication network) having any form or medium. Instances of communication networks include a local area network (LAN), a wide area network (WAN), an internetwork (such as the internet), an ad-hoc network (which executes, in response to a search instruction for a message record, a search step based on the message record, and stops the search step on the basis that a preset stop condition is satisfied), and any currently-known or future-developed network.

The above computer-readable medium may be contained in the above electronic device; and may exist independently and not be assembled into the electronic device.

The above computer-readable medium carries one or more programs, and when executed by the electronic device, the above one or more programs cause the electronic device to acquire target message information based on a search instruction for a message record, where the search instruction instructs to search for a target message matching a target search term from the message record; and present the target message information in a sub-region of a first interface: where the first interface is provided with a switching control configured to switch an unfolded state and a folded state of at least one sub-region, target message information presented in each sub-region belongs to the same message source, target message information presented in different sub-regions belongs to different message sources, and a region area of the sub-region in the folded state is less than a region area of the sub-region in the unfolded state.

In some embodiments, presenting the target message information includes: presenting target message information corresponding to the sub-region.

In some embodiments, the switching control includes a first-type switching control, the first-type switching control is configured to switch presenting states of the sub-region, and the presenting states of the sub-region include the unfolded state and the folded state; and the electronic device is further configured to switch, in response to detecting a trigger operation for the first-type switching control, presenting states of a sub-region corresponding to the triggered first-type switching control.

In some embodiments, presenting the target message information in the sub-region of the first interface includes: presenting, in the sub-region in the unfolded state, at least one of: a message source identifier and at least part of message content of a first number of target message.

In some embodiments, presenting the target message information in the sub-region of the first interface includes: presenting, in the sub-region in the folded state, at least one of: a message source identifier and at least part of message content of a second number of target message, where the second number is less than the first number.

In some embodiments, the at least part of message content includes at least one of a search term hitting the target message, an identifier of a user sending the target message, and context information of the target search term.

In some embodiments, the sub-region includes a first acquisition control; and the electronic device is further configured to present, in response to detecting a trigger operation for the first acquisition control and in a sub-region corresponding to the triggered first acquisition control, unpresented target message information of a message source corresponding to the triggered first acquisition control.

In some embodiments, the sub-regions in the first interface are sequenced according to time of the latest target messages of a message source corresponding to the sub-regions.

In some embodiments, the first interface comprises a second acquisition control, and the second acquisition control instructs to present unpresented target message information of the message source; and the electronic device is further configured to present, in response to detecting a trigger operation for the second acquisition control, the unpresented target message information of the message source in the first interface.

In some embodiments, the presented target message information indicates a target message in a first preset time period, the first interface includes a third acquisition control, and the third acquisition control instructs to acquire target message information of a target message in a second preset time period; and the electronic device is further configured to present, in response to detecting a trigger operation for the third acquisition control, target message information of the target message in the second time period.

In some embodiments, the switching control further includes a second-type switching control; and the electronic device is further configured to switch, in response to detecting a trigger operation for the second-type switching control, each sub-region to the folded state.

In some embodiments, the switching control includes a third-type switching control: and the electronic device is further configured to switch, in response to detecting a trigger operation for the third type switching control, each sub-region to the unfolded state.

In some embodiments, the electronic device is further configured to display, in response to detecting a trigger operation for the target message information in the sub-region, a message context of the triggered target message in a preview region of the first interface.

In some embodiments, the electronic device is further configured to display, in response to detecting a trigger operation for the target message information in the sub-region, a message context of the triggered target message and present a skip control; and present, in response to an operation for the skip control, a message interaction interface corresponding to the triggered message source.

In some embodiments, the electronic device is further configured to present a filtering interface in response to detecting a trigger operation for a filtering control, where the filtering interface is configured to search for a message satisfying a filtering condition from a target message.

In some embodiments, the target message information presented in the first interface is obtained through a first step, and the first step includes: executing, in response to a search instruction for a message record, a search step based on the message record, and stop the search step on the basis that a preset stop condition is satisfied: where the search step includes search for a target message matching a target search term, the preset stop condition includes a condition that a preset first number of target message source is found, and the target message source includes the target message matching the target search term.

In some embodiments, executing, in response to the search instruction for the message record, the search step based on the message record, and stopping the search step on the basis that the preset stop condition is satisfied include: executing a first search sub-step for the message record; and stopping the first search sub-step on the basis that a first stop sub-condition is satisfied: where a search range of the first search sub-step is a message record corresponding to a user, the message record is stored in a server, and the second stop sub-condition includes a condition that a first number of target message source is found.

In some embodiments, the first search sub-step includes: determining, in response to searching for a second number of target message, a number of a message source to which a second number of target message belongs; and determining whether a first stop sub-condition is satisfied based on the determined number of a message source.

In some embodiments, the first search sub-step includes: search for the target message in the message record and record a target message source to which the target message belongs during the searching; and determine whether a first stop sub-condition is satisfied according to a number of a target message source obtained after de-duplication.

In some embodiments, executing, in response to the search instruction for the message record, the search step based on the message record, and stopping the search step on the basis that the preset stop condition is satisfied further include: executing a second search sub-step for each target message source in response to stopping the first search sub-step, and stopping the second search sub-step on the basis that a second stop sub-condition is satisfied; where a search range of the first search sub-step is a message record corresponding to the target message source: the second stop sub-condition includes any one of a condition that a fourth number of target message is found from the target message source, and a condition that a message record of the target message source is traversed.

The above computer-readable medium carries one or more programs. When executed by the electronic device, the above one or more programs cause the electronic device to execute, in response to a search instruction for a message record, a search step based on the message record, and stop the search step on the basis that a preset stop condition is satisfied; where the search step includes search for a target message matching a target search term, the preset stop condition includes a condition that a preset third number of target message source is found, and the target message source includes the target message matching the target search term.

In some embodiments, executing, in response to the search instruction for the message record, the search step based on the message record, and stopping the search step on the basis that the preset stop condition is satisfied include: executing a first search sub-step for the message record; and stopping the first search sub-step on the basis that a first stop sub-condition is satisfied: where a search range of the first search sub-step is a message record corresponding to a user, the message record is stored in a server, and the first stop sub-condition includes a condition that a third number of target message source is found.

In some embodiments, the first search sub-step includes: determining, in response to finding a fourth number of target message, a number of a message source to which the fourth number of target messages belong; and determining whether a first stop sub-condition is satisfied based on the determined number of a message source.

In some embodiments, the first search sub-step includes: searching for the target message in the message record and record a target message source to which the target message belongs during the searching; and determining whether a first stop sub-condition is satisfied according to a number of a target message source obtained after de-duplication.

In some embodiments, executing, in response to the search instruction for the message record, the search step based on the message record, and stopping the search step on the basis that the preset stop condition is satisfied further include: execute a second search sub-step for each target message source in response to stopping the first search sub-step, and stop the second search sub-step on the basis that a second stop sub-condition is satisfied; where a search range of the first search sub-step is a message record corresponding to the target message source: the second stop sub-condition includes any one of a condition that a fifth number of target message is found from the target message source, and a condition that a message record of the target message source is traversed.

In some embodiments, the messages in the message record are sequenced in a chronological order; and the search step includes: searching for the target message corresponding to the target search term from the message record in the chronological order.

In some embodiments, the electronic device is further configured to generate to-be-presented target message information in response to stopping the search step, wherein the to-be-presented target message information is configured to be showed in a first interface.

In some embodiments, the first interface includes a first acquisition control corresponding to a message source, and the first acquisition control instructs to acquire an unpresented message corresponding to the message source. The electronic device is further configured to search, in response to receiving a first acquisition instruction generated by a trigger for the first acquisition control, for a target message from a message record corresponding to a message source, and obtain a first search result, where the first acquisition instruction includes a message source identifier.

In some embodiments, the first interface includes a second acquisition control, and the second acquisition control instructs to acquire unpresented target message information of message sources. The electronic device is further configured to search, in response to receiving a second acquisition instruction generated by a trigger for the second acquisition control, for target messages from a message record of a user, cluster the target messages according to message sources, and obtain a second search result.

In some embodiments, executing, in response to the search instruction for the message record, the search step based on the message record, and stopping the search step on the basis that the preset stop condition is satisfied include: executing the search step in the message record of a user in a first time period.

In some embodiments, the presented target message information indicates a target message in a first preset time period, the first interface includes a third acquisition control, and the third acquisition control instructs to acquire target message information of target messages in a second preset time period. The electronic device is further configured to search, in response to receiving a third acquisition instruction generated by a trigger for the third acquisition control, for target messages from a message record of a user in the second preset time period, cluster the target messages according to message sources, and obtain a third search result.

In some embodiments, a start time point of the first preset time period is later than an end time point of the second preset time period.

In some embodiments, the message record of a user includes a first message set and a second message set. The first message set is a set of messages in a first preset time period, and the second message set is a set of messages in a second preset time period. Storage and search of the first message set are carried out based on a first server. Storage and search of the second message set are carried out based on a second server. A speed of searching for a message by the first server is greater than a speed of searching for a message by the second server.

A computer program code for executing operations of this disclosure may be written in one or more programming languages or combinations thereof. The above programming languages include, but are not limited to, object-oriented programming languages such as Java, Smalltalk, “executing, in response to a search instruction for a message record, a search step based on the message record, and stopping the search step on the basis that a preset stop condition is satisfied” ++, and conventional procedural programming languages such as “executing, in response to a search instruction for a message record, a search step based on the message record, and stopping the search step on the basis that a preset stop condition is satisfied” languages or similar programming languages. The program code may be executed entirely on a user computer, executed partially on the user computer, executed as a stand-alone software package, executed partially on the user computer and partially on a remote computer, or executed entirely on the remote computer or a server. In a case where the remote computer is involved, the remote computer may be connected to the user computer by means of any type of network, which include a local area network (LAN) or a wide area network (WAN), or may be connected to an external computer (for example, by means of the internet by an internet service provider).

Flow diagrams and block diagrams in figures show system architectures, functions and operations, which may be achieved according to systems, methods and computer program products in various embodiments of this disclosure. In this regard, each block in flow diagrams or block diagrams can represent a module, a program segment, or part of a code, which include one or more executable instructions for implementing specified logical functions. It should also be noted that in some substitutive implementations, functions noted in blocks can also occur in sequences different from those in figures. For example, functions represented by two continuous blocks can be executed substantially in parallel in practice, and sometimes implemented in reverse sequences, which depends on the involved functions. It should also be noted that each block in flow diagrams and/or block diagrams, and combinations of the blocks in the flow diagrams and/or the block diagrams, can be implemented by means of dedicated hardware-based systems that execute specified functions or operations, or can be implemented by means of combinations of dedicated hardware and computer instructions.

Units described in embodiments of this disclosure can be implemented in a form of software or hardware. In some cases, a name of a unit does not constitute a limitation on the unit itself. For example, an acquisition unit can also be described as a unit for acquiring target message information.

At least part of the functions described above herein can be executed by one or more hardware logic components. For example, without limitation, exemplary types of hardware logic components that may be used include: a field programmable gate array (FPGA), an application specific integrated circuit (ASI) (which executes, in response to a search instruction for a message record, a search step based on the message record, and stops the search step on the basis that a preset stop condition is satisfied), an application specific standard product (ASSP), a system on chip (SOC) (which executes, in response to a search instruction for a message record, a search step based on the message record, and stops the search step on the basis that a preset stop condition is satisfied), a complex programmable logic device (PLD) (which executes, in response to a search instruction for a message record, a search step based on the message record, and stops the search step on the basis that a preset stop condition is satisfied), etc.

In a context of this disclosure, a machine-readable medium may be a tangible medium, which may include or store a program for being used by or in connection with an instruction execution system, apparatus or device. The machine-readable medium may be a machine-readable signal medium or a machine-readable storage medium. The machine-readable medium may include, but is not limited to, electronic, magnetic, optical, electromagnetic, infrared or semiconductor systems, apparatuses or devices, or any suitable combination of the foregoing. More particular instances of the machine-readable storage medium can include an electrical connection based on one or more wires, a portable computer disk, a hard disk, a random-access memory (RAM), a read-only memory (ROM), an erasable programmable read-only memory (EPROM or a flash memory), an optical fiber, a portable compact disk read-only memory (CD-ROM) (which executes, in response to a search instruction for a message record, a search step based on the message record, and stops the search step on the basis that a preset stop condition is satisfied), an optical storage device, a magnetic storage device or any suitable combination of the foregoing.

The above description is only illustrative of preferred embodiments of this disclosure and employed technical principles. Those skilled in the art should understand that the scope involved in this disclosure is not limited to technical solutions formed by a specific combination of the above technical features, and should also cover other technical solutions formed by any combination of the above technical features or their equivalent features without departing from the inventive concept, such as technical solutions formed by interchanging the above features and (non-limitative) technical features having similar functions as disclosed in this disclosure.

Moreover, although various operations are depicted in a specific order, it should not be understood that these operations are required to be executed in a shown specific order or in a sequential order. In certain circumstances, multitasking and parallel processing may be advantageous. Similarly, although several specific implementation details are included in the above discussion, these details should not be construed as limitations on the scope of this disclosure. Some features described in contexts of separate embodiments can also be implemented in a single embodiment in combination. Conversely, various features described in a context of a single embodiment can also be implemented in a plurality of embodiments separately or in any suitable sub-combination.

Although the subject matter is described in language specific to structural features and/or methodological logical actions, it should be understood that the subject matter defined in the appended claims is not necessarily limited to the specific features or actions described above. Conversely, the specific features and actions described above are merely instance forms for implementing the claims.

1. A presenting method, comprising:
acquiring target message information based on a search instruction for a message record, wherein the search instruction instructs to search for a target message matching a target search term from the message record; and
presenting the target message information in a sub-region of a first interface;
wherein the first interface is provided with a switching control configured to switch an unfolded state and a folded state of at least one sub-region, target message information presented in each sub-region belongs to a same message source, target message information presented in different sub-regions belongs to different message sources, and a region area of the sub-region in the folded state is less than a region area of the sub-region in the unfolded state.

2. The method according to claim 1, wherein presenting the target message information comprises: presenting target message information corresponding to the sub-region.

3. The method according to claim 1, wherein the switching control comprises a first-type switching control, the first-type switching control is configured to switch presenting states of the sub-region, and the presenting states of the sub-region comprise the unfolded state and the folded state; and
the method further comprises:
switching, in response to detecting a trigger operation for the first-type switching control, presenting states of a sub-region corresponding to the triggered first-type switching control.

4. The method according to claim 1, wherein presenting the target message information in the sub-region of the first interface comprises at least one of:
presenting, in the sub-region in the unfolded state, at least one of: a message source identifier or at least part of message content of a first number of target message; and
presenting, in the sub-region in the folded state, at least one of: a message source identifier or at least part of message content of a second number of target message, wherein the second number is less than the first number.

5. The method according to claim 3, wherein the at least part of message content comprises at least one of: a search term hitting the target message, an identifier of a user sending the target message, or context information of the target search term.

6. The method according to claim 1, wherein the sub-region comprises a first acquisition control; and
the method further comprises:
presenting, in response to detecting a trigger operation for the first acquisition control and in a sub-region corresponding to the triggered first acquisition control, unpresented target message information in a message source corresponding to the triggered first acquisition control.

7. The method according to claim 1, wherein the sub-regions in the first interface are sequenced according to time of the latest target messages of a message source corresponding to the sub-regions.

8. The method according to claim 1, wherein the first interface comprises a second acquisition control, and the second acquisition control instructs to present unpresented target message information of the message source; and
the method further comprises:
presenting, in response to detecting a trigger operation for the second acquisition control, the unpresented target message information of the message source in the first interface.

9. The method according to claim 1, wherein the presented target message information indicates a target message with a sending time and/or a receiving time in a first preset time period, the first interface comprises a third acquisition control, and the third acquisition control instructs to acquire target message information of a target message in a second preset time period; and
the method further comprises:
presenting, in response to detecting a trigger operation for the third acquisition control, the target message information of the target message in the second time period.

10. The method according to claim 1, wherein the switching control further comprises a second-type switching control; and
the method further comprises:
switching, in response to detecting a trigger operation for the second-type switching control, each sub-region to the folded state.

11. The method according to claim 1, wherein the switching control comprises a third-type switching control; and
the method further comprises:
switching, in response to detecting a trigger operation for the third-type switching control, each sub-region to the unfolded state.

12. The method according to claim 1, further comprising:
displaying, in response to detecting a trigger operation for the target message information in the sub-region, a message context of the triggered target message in a preview region of the first interface.

13. The method according to claim 1, further comprising:
displaying, in response to detecting a trigger operation for the target message information in the sub-region, a message context of the triggered target message and presenting a skip control; and
presenting, in response to an operation for the skip control, a message interaction interface corresponding to a triggered message source.

14. The method according to claim 1, further comprising:
presenting a filtering interface in response to detecting a trigger operation for a filtering control, wherein the filtering interface is configured to search for a message satisfying a filtering condition from a target message.

15. The method according to claim 1, wherein the target message information presented in the first interface is obtained through a first step, and the first step comprises:
executing, in response to the search instruction for the message record, a search step based on the message record, and stopping the search step on the basis that a preset stop condition is satisfied; wherein
the search step comprises searching for the target message matching the target search term, the preset stop condition comprises a condition that a preset third number of target message source is found, and the target message source comprises the target message matching the target search term.

16. The method according to claim 15, wherein executing, in response to the search instruction for the message record, the search step based on the message record, and stopping the search step on the basis that the preset stop condition is satisfied comprise:
executing a first search sub-step for the message record; and
stopping the first search sub-step on the basis that a first stop sub-condition is satisfied; wherein
a search range of the first search sub-step is a message record corresponding to a user, the message record is stored in a server, and the first stop sub-condition comprises a condition that the third number of target message source is found.

17. The method according to claim 16, wherein the first search sub-step comprises:
determining, in response to finding a fourth number of target message, a number of a message source to which the fourth number of target message belongs; and
determining whether the first stop sub-condition is satisfied according to the determined number of a message source;
or,
wherein the first search sub-step comprises:
searching for the target message from the message record and recording a target message source to which the target message belongs during the searching; and
determining whether the first stop sub-condition is satisfied according to a number of a target message source obtained after de-duplication.

18. (canceled)

19. The method according to claim 16, wherein executing, in response to the search instruction for the message record, the search step based on the message record, and stopping the search step on the basis that the preset stop condition is satisfied further comprise:
executing a second search sub-step for each target message source in response to stopping the first search sub-step, and stopping the second search sub-step on the basis that a second stop sub-condition is satisfied; wherein
the search range of the first search sub-step is a message record corresponding to the target message source; and
the second stop sub-condition comprises any one of: a condition that a fifth number of target message is found from the target message source, or a condition that the message record of the target message source is traversed.

20-34. (canceled)

35. An electronic device, comprising:
one or more processors; and
a storage means, configured to store one or more programs,
the one or more programs, when executed by the one or more processors, causing the one or more processors to implement:
acquiring target message information based on a search instruction for a message record, wherein the search instruction instructs to search for a target message matching a target search term from the message record; and
presenting the target message information in a sub-region of a first interface;
wherein the first interface is provided with a switching control configured to switch an unfolded state and a folded state of at least one sub-region, target message information presented in each sub-region belongs to a same message source, target message information presented in different sub-regions belongs to different message sources, and a region area of the sub-region in the folded state is less than a region area of the sub-region in the unfolded state.

36. A non-transitory computer-readable medium, storing a computer program thereon, wherein the program, when executed by a processor, implements:
acquiring target message information based on a search instruction for a message record, wherein the search instruction instructs to search for a target message matching a target search term from the message record; and
presenting the target message information in a sub-region of a first interface;
wherein the first interface is provided with a switching control configured to switch an unfolded state and a folded state of at least one sub-region, target message information presented in each sub-region belongs to a same message source, target message information presented in different sub-regions belongs to different message sources, and a region area of the sub-region in the folded state is less than a region area of the sub-region in the unfolded state.
